(19) United States
(12) Patent Application Publication
(10) Pub. No.: US 2017/0250552 A1
(43) Pub. Date: Aug. 31, 2017

(54) BATTERY ASSEMBLY AND CHARGING METHOD THEREOF, AND ELECTRONIC CIGARETTE

(71) Applicant: Huizhou Kimree Technology Co., Ltd., Huizhou, Guangdong (CN)

(72) Inventor: Qiuming Liu, Shenzhen, Guangdong (CN)

(21) Appl. No.: 15/519,833

(22) PCT Filed: Oct. 17, 2014
(86) PCT No.: PCT/CN2014/088874

§ 371 Date: Apr. 17, 2017

(51) Int. Cl. H02J 7/00; H05B 1/02; H01M 10/44; A24F 47/00; H01M 10/48

(52) U.S. Cl. CPC H02J 7/0029; A24F 47/008; H01M 10/486; H01M 10/443; H02J 7/007; H05B 1/0244; H01M 2220/30; H05B 2203/021

(57) ABSTRACT

Provided are a battery assembly and charging method thereof, and an electronic cigarette; the battery assembly is used for combining with a vaporizer to form an electronic cigarette; the battery assembly comprises a charging port, a battery module, a charging control module, and a temperature monitoring module used for measuring the temperature value of said battery module; the charging control module is separately connected to the charging port, the battery module, and the temperature monitoring module; the charging control module is used for receiving DC power via the charging port so as to charge the battery module via an external power supply, and controlling the charging input of the battery module in accordance with the temperature value of the battery module, measured by the temperature monitoring module. The battery assembly monitors in real time the temperature of the battery module, effectively preventing explosion, burning, and other hazardous situations from occurring.

### FIELD OF THE INVENTION

The present application relates to the field of electronic cigarettes, and more particularly relates to a battery assembly and charging method thereof, and an electronic cigarette.

### BACKGROUND OF THE INVENTION

A traditional electronic cigarette comprises a vaporizer assembly and a battery assembly, the vaporizer assembly comprises an atomizer, an airflow sensing assembly and an electric heating wire; the battery assembly supplies power to the airflow sensing assembly. When an user absorbs the electronic cigarette, the airflow sensing assembly senses the change of airflow and outputs voltage to the electric heating wire, the electric heating wire is heated to atomize e-liquid in the atomizer so as to generate smoke for the user to absorb.

Specifically, a high-speed airflow can be formed when a smoker inhales, and an airflow sensor senses the airflow and then generate a smoking signal, according to the detected smoking signal, a controller generates a switch command and sends it to a switch assembly, the atomizer is started via the switch assembly, after the atomizer is opened and the heating wire is heated, the e-liquid is heated and evaporated to be atomized, and smoke is formed; In addition to disposable cigarettes, battery assemblies of existing electronic cigarettes all have charging functions.

However, an existing battery assembly of an electronic cigarette does not have a charging and temperature detection function, once an accident occurs, a charge and discharge circuit is abnormal, and charge and discharge current will be very large, if there isn't a monitoring circuit, battery is continuously charged and discharged in the heavy current, and the internal heat of the battery is accumulated, it will cause the explosion, burning and other hazardous situation when a certain degree is reached.

### SUMMARY OF THE INVENTION

The present application is to provide an battery assembly with charging and temperature detection function and charging method thereof, and an electronic cigarette used this battery assembly, aiming at the defect that there isn't temperature detection in present application to cause explosion, burning and others dangerous results in the charging and discharging process.

The technical solutions of the present application for solving the technical problems are as follows: In one aspect, a battery assembly used for combining with a vaporizer assembly to form an electronic cigarette; the battery assembly comprises a charging port, a battery module, and a charging control module; the battery assembly further comprises a temperature monitoring module used for measuring temperature value of the battery module,

the charging control module is electrically connected to the charging port, the battery module and the temperature monitoring module respectively;

the charging control module is used for charging the battery module via an external power supply in the form of DC power via the charging port, as well as controlling charging input of the battery module in accordance with the temperature value of the battery module measured by the temperature monitoring module.

In the embodiment, the charging control module includes a charging control chip, an output end of the charging control chip is electrically connected to a anode of the battery module; a TS pin of the charging control chip is electrically connected to the temperature monitoring module and is further connected to a cathode of the battery module via the temperature monitoring module.

In the embodiment, the charging control chip has a preset temperature threshold, output voltage of the charging control chip is controlled in according with a comparing result between the temperature threshold and the temperature value obtained from the temperature monitoring module via the TS pin of the charging control chip.

In the embodiment, the temperature monitoring module includes a first resistor and a second resistor, a ISET pin of the charging control chip is grounded via the first resistor, and a PRE-TERM pin of the charging control chip is grounded via the second resistor.

In the embodiment, the temperature monitoring module is a NTC thermistor, the NTC thermistor detect temperature of the battery module by clinging the battery module.

In the embodiment, type of charging control chip is BQ24090.

In the embodiment, the battery assembly further includes a microprocessor module, the microprocessor module separately connects to the battery module and the charging control module, the microprocessor module detects the voltage of the battery module and determines whether temperature of the battery module is abnormal and hints the abnormal temperature status in accordance with charging status signal of the battery module received from the charging control module.

In the embodiment, the microprocessor module includes a microprocessor chip, a voltage comparison module and a prompt module separately connecting to the microprocessor chip, a XIN pin of the microprocessor chip is electrically connected to a CHG pin of the charging control chip, a reset pin of the microprocessor chip is electrically connected to the input end of DC.

In the embodiment, the input end of DC is grounded via a first divider resistor and a second divider resistor in series, the reset pin is electrically connected to connection end of the first divider resistor and the second divider resistor.

In the embodiment, the voltage comparison module includes a third resistor, a fourth resistor, a fifth resistor, a first capacitance and a three terminal voltage regulator, therein,

an end of the third resistor is electrically connected to the anode of the battery module, the other end of the third resistor is electrically connected to AIN3 pin of the microprocessor chip;

an end of the fourth resistor is electrically connected to the AIN3 pin, the end of the fourth resistor is electrically connected to first end of the first capacitance and AIN2 pin of the microprocessor chip;

an end of the fifth resistor is electrically connected to the anode of the battery module, the other end of the fifth resistor is electrically connected to second end of the first capacitance and a cathode of the three terminal voltage regulator;

an anode of the three terminal voltage regulator is electrically connected to the AIN2 pin, a gate of the three terminal voltage regulator is electrically connected to second end of the first capacitance, the cathode of the three terminal voltage regulator is electrically connected to one end of the fifth resistor and AVREFG pin of microprocessor chip.

In the embodiment, the microprocessor module includes switch module connected to the microprocessor chip, output end of the switch module is connected to the vaporizer assembly.

In the embodiment, the switch module includes a field effect transistor(FET) and a sixth resistor, a grid of the FET is electrically connected to PWM3 pin of microprocessor chip, a source of the FET is grounded, a drain of the FET is the output end of the switch module, an end of the sixth resistor is electrically connected to the grid of the FET, the other end of the sixth resistor is grounded.

In the embodiment, the prompt module includes a sound device and/or a LED light.

In the embodiment, the microprocessor module also includes the airflow sensor connected to Xout pin of the microprocessor chip, the anode of battery module is electrical connected to the airflow sensor and supplies power to airflow sensor.

In another aspect, a charging and discharging control method for a battery assembly is provided; and the charging and discharging control method comprises:

a power adapter is electrically connected to an external power supply via a charging port;

a temperature monitoring module detects to the temperature of the battery module in real time;

a charging control module controls charging input of the battery module according to detected temperature of the battery module.

In the embodiment of the charging and discharging control method, in the charging process, the charging control module has a preset temperature threshold range and the temperature monitoring module senses temperature change of the battery module; when a temperature value of the battery module is in the threshold range, the charging control module charges the battery module in accordance with a set charging input, when the temperature value of the battery module is out the threshold, the charging control module reduces the charging input of the battery module.

In the embodiment of the charging and discharging control method, the battery assembly also includes a microprocessor module connected to the charging control module, in the charging and discharging process, the microprocessor module detects voltage of the battery module and receives charging status signal from the charging control module, the microprocessor module has a preset reference voltage and compares the detected voltage of the battery module with the reference voltage, when the voltage of the battery module is different from the reference voltage, the microprocessor module determines temperature of the battery module being abnormal and prompts abnormal information.

In the embodiment of the charging and discharging control method, the charging control module has multiple threshold ranges,

if temperature of the battery module sensed by the temperature monitoring module is in the range of 10-45 degree, the battery module is charged at a setting current;

if temperature of the battery module sensed by the temperature monitoring module is in the range of 45-60 degree, the maximum charging cut-off voltage of the battery module is 4.1 V;

if temperature of the battery module sensed by the temperature monitoring module is in the range of 0-10 degree, the charging current of the battery module is halved;

the temperature of the battery module sensed by the temperature monitoring module is greater than 60 degree or less than 0 degree, the charging is fault, charging circuit of the battery module is cut off.

Furthermore, an electronic cigarette is provided, the electronic cigarette comprises the vaporizer assembly used for vaporizing e-liquid and the battery assembly used for supplying power to the vaporizer assembly, the battery assembly comprises a charging port, a battery module, and a charging control module; the battery assembly further comprises a temperature monitoring module used for measuring temperature value of the battery module,

the charging control module is electrically connected to the charging port, the battery module and the temperature monitoring module respectively;

the charging control module is used for receiving DC power via the charging port to charge the battery module via an external power supply, and controlling charging input of the battery module in accordance with temperature value of the battery module measured by the temperature monitoring module.

In the embodiment, the control unit further includes a microprocessor, the microprocessor separately connects to the battery module and the charging control module, the microprocessor detects discharged voltage of the battery module, determines whether temperature of the battery module is abnormal and hints abnormal temperature status in accordance with charging status signal of the battery module received from the charging control module.

When implementing the a battery assembly and charging method thereof, and an electronic cigarette of the present application, the following advantageous effects can be achieved: According to the invention, the battery assembly in the use process of the electronic cigarette, the temperature monitoring module is used for detecting the temperature of the battery module in the battery assembly, meanwhile, the charging input of the battery module is controlled according to the temperature detection value to charge the internal built-in battery, the battery assembly monitors the temperature of the battery module in real time, effectively preventing explosion, burning, and other hazardous situations from occurring.

### BRIEF DESCRIPTION OF THE DRAWINGS

The present application will be further described with reference to the accompanying drawings and embodiments in the following, in the accompanying drawings:

FIG. 1 is a block diagram of a battery assembly of a first embodiment of the present application;

FIG. 2 is a circuit schematic view of the battery assembly shown in FIG. 1;

FIG. 3 is a block diagram of a battery assembly of a second embodiment of the present application;

FIG. 4 is a temperature alarm circuit schematic view associated with the temperature monitoring module of the battery assembly shown in FIG. 3;

FIG. 5 is a partially enlarged view of the circuit shown in FIG. 4;

FIG. 6 is another partial enlarged view of the circuit shown in FIG. 4;

FIG. 7 is a circuit schematic view of an battery assembly of another embodiment of the present application;

FIG. 8 is a system block diagram of an electronic cigarette according to the present invention.

### DETAILED DESCRIPTION OF THE PREFERRED EMBODIMENT

To make the technical feature, objective and effect of the present application be understood more clearly, now the specific implementation of the present application is described in detail with reference to the accompanying drawings and embodiments.

A battery assembly of the present invention detects temperature of a battery module in the battery assembly, and then controls charging input of the battery module to charge the internal built-in battery according to detected temperature value, so the battery assembly can monitor the temperature of the battery module in real time, and effectively prevent explosion, burning, and other hazardous situations from occurring and improving safety performance of the electronic cigarette.

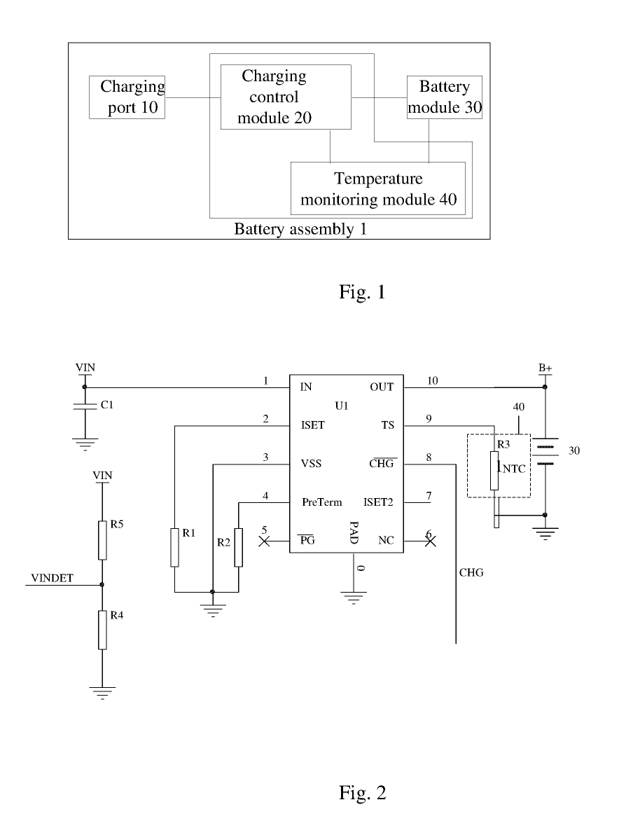

In detail, as shown in FIG. 1, the battery assembly 1 in the first embodiment of the present invention is combined with a vaporizer assembly to form an electronic cigarette, the battery assembly 1 includes a charging port 10 for connecting an external power supply, such as connecting to a commercial power supply via a power adapter, or connecting to a mobile power supply or other devices. Preferably, the charging port is a USB port. The battery assembly 1 further includes a battery module 30 and a charging control module 20, and also includes a temperature monitoring module 40 for detecting a temperature value of the battery module 30. Preferably, the temperature monitoring module 40 is a NTC thermistor. As can be seen from the FIG. 1, the charging control module 20 is electrically connected with the charging port 10, the battery module 30 and the temperature monitoring module 40 respectively. The charging control module 20 is configured to receive direct current from the charging interface 10 to obtain an external power supply and charge the battery module 30, the charging control module 20 controls the charging input of the battery module 30 according to the temperature value of the battery module 30 monitored by the temperature monitoring module 40.

In detail, in the charging control circuit as shown in FIG. 2, the charging control module 20 includes a charging control chip U1, the charging control chip U1 is a control circuit for charging management, temperature monitor and control, in this embodiment, preferably, a model of the charging control chip U1 is a BQ24090. An output pin of the charging control chip U1 is electrically connected to an anode of the battery module 30, a TS pin of the charging control chip is electrically connected to the temperature monitoring module 40 (NTC thermistor R3 in FIG. 2) and is further electrically connected to a cathode of the battery module 30 via the NTC thermistor R3. The charge control module 20 further includes a first resistor R1 and a second resistor R2, an ISET pin of the charging control chip U1 is grounded via the first resistor R1, a PRE-TERM pin of the charging control chip U1 is grounded via the second resistor R2. The first resistor R1 can be set for a constant charge current between 50 and 1250 mA, the second resistor R2 can be set for the pre-charge current as a percentage of the constant charge current. The resistor R3 is an NTC thermistor, and can be a chip type or a direct-insert type, both types of the resistor R3 are required to abut against the battery module 30, a preferred NTC model in this embodiment is SDNT 1608X103J3380.

Specifically, the charging control chip U1 has a preset temperature threshold, the charging control chip U1 compares the temperature threshold value with the temperature value obtained by the NTC thermistor at the TS pin, controls output voltage on the output end pin of the charging controller chip U1 according to comparison result, and then adjusts the charging input of the battery module 30.

In particular embodiments, the charging control chip can be set multiple temperature threshold ranges, eg, if the NTC thermistor R3 senses the temperature of the battery module 30 is in the range of 10 degree and 45 degree, the battery module 30 is charged according to current set by the second resistor R2, if the temperature is in the range of 45 degree and 60 degree, maximum charge cut-off voltage is 4.1V, if the temperature is in the range of 0 degree and 10 degree, the charging current is halved; if the temperature i is greater than 60 degree or less than 0 degree, the charging is abnormal, and the charging circuit is cut off.

The battery assembly 1 in the further embodiment of the present invention further includes a microprocessor module 50, the microprocessor module 50 separately connects to the battery module 30 and the charging control module 20, the microprocessor module 50 is configured to detect the voltage of the battery module 30, determine whether the temperature of the battery module 30 is abnormal and hint abnormal temperature status in accordance with detected voltage and charging status single received from the charging control module 20. Meanwhile, the microprocessor module 50 is further connected to a signal light 52 and a sound device 53, configured to hint the abnormal temperature status, and the microprocessor module 50 controls the vaporizer switch 51 to on/off depending on the temperature when the microprocessor module 50 is connected to the vaporizer assembly 2.

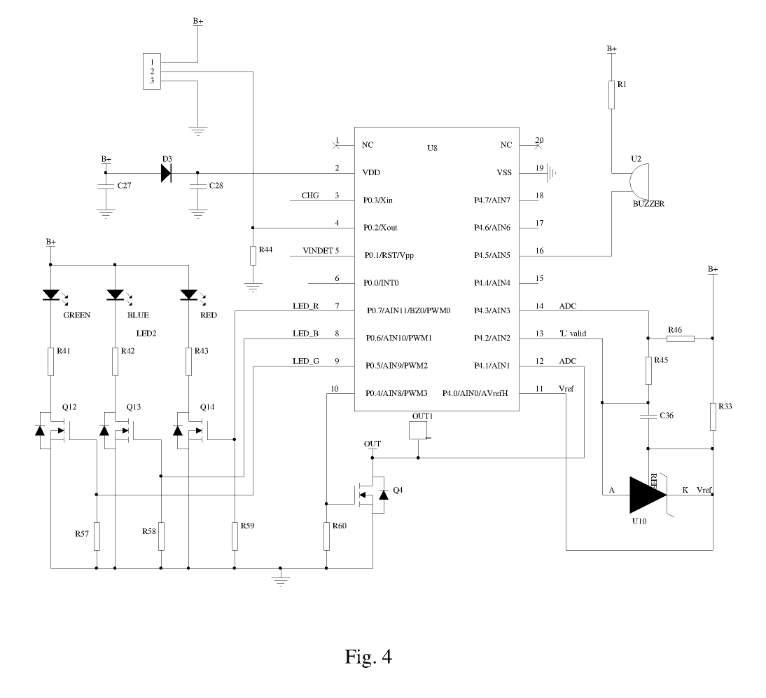

As shown in FIG. 4, the microprocessor module 50 includes a microprocessor chip U8 and a voltage comparison module and a prompt module that are connected to the microprocessor chip U8 respectively. A XIN pin of the microprocessor chip U8 is electrically connected to the CHG pin of the charging control chip U1, as shown in FIG. 2, a reset pin of the microprocessor chip U8 is electrically connected to an input end of DC VIN. As shown in FIG. 2, the input end of DC VIN is grounded via a first divider resistor R5 and a second divider resistor R4 in series, the reset pin is electrically connected to connection end of the first divider resistor R5 and the second divider resistor R4. An airflow sensor is connected to a Xout pin of the microprocessor chip U8, the anode of the battery module is electrically connected to the airflow sensor and supply power to airflow sensor.

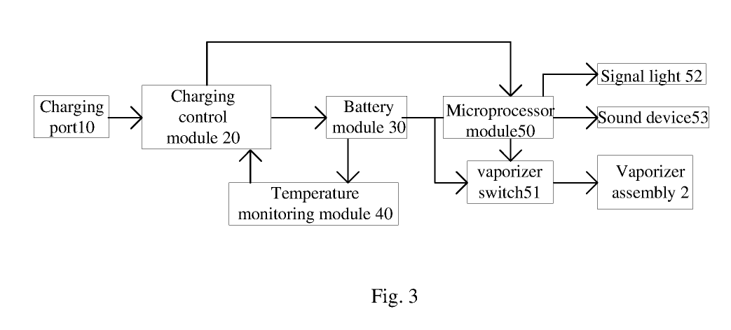

The prompt module includes the signal light 52 and/or the sound device 53 in FIG. 3. In this embodiment, preferably, a model of the microprocessor chip U8 is a SN8P2712, the sound device 53 is a buzzer U2. In this embodiment, one end of the buzzer U2 is electrically connected to a P4.5 pin of the chip U8, and the other end of the buzzer U2 is electrically connected to the anode of the battery module 30. The signal light 52 includes three light emitting diodes for red, green and blue three colors, anodes of three light emitting diode are respectively connected to the anode B+ of battery module 30, cathodes of three light emitting diodes are connected to three PWM output ends of the microprocessor chip U8 via MOSFET Q12/Q13/Q14 respectively, in this embodiment, the three PWM output ends are P0.5-P0.7 pins. Preferably, the MOSFET Q12/Q13/Q14 is enhanced MOSFET. Preferably, in order to prevent the light emitting diode from being damaged due to the over current in the working, each light emitting diode and each MOSFET is respectively connected via a resistor R41/R42/R43. Specifically, as shown in FIG. 4, the green light emitting diode as an example, the anode of the green light emitting diode is connected to the positive pole of the battery module 30, the cathode of the green light emitting diode is connected to a drain of the MOSFET Q12 via the resistor R41, a grid of MOSFET Q12 is connected to the PWM output pin P0.5 of the microprocessor chip U8 and is grounded via a protection resistance R57 at the same time, a source of the MOSFET Q12 is grounded. The connection methods of the other light emitting diodes with the resistor R42/R43, the field effect transistor Q13/Q14 and the resistor R58/R59 are similar to that of the green light emitting diode, not repeat here.

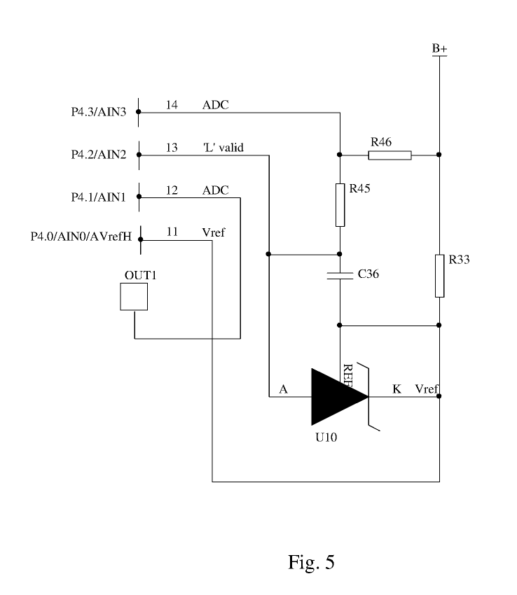

FIG. 5 is a enlarged view of the voltage comparison module in FIG. 4, a three terminal voltage regulator U10 supplies reference voltage. A pole of the three terminal voltage regulator U10 is electrically connected to the P4.2 pin of the microprocessor chip U8, a K pole of the three terminal voltage regulator U10 is electrically connected to the anode B+ of the battery module 30 via a resistor R33, a R pole of the three terminal voltage regulator U10 is electrically connected to the P4.2 pin via a capacitance C36, the R pole conducts to one end of the resistor R33, and the end is close to the K pole. P4.2 pin is connected to P4.3 pin via a resistor R45, and one end of the resistor R45 is connected to the anode B+ of the battery module 30 via a resistor R46, and the end of the resistor R45 is close to the pin near P4.3.

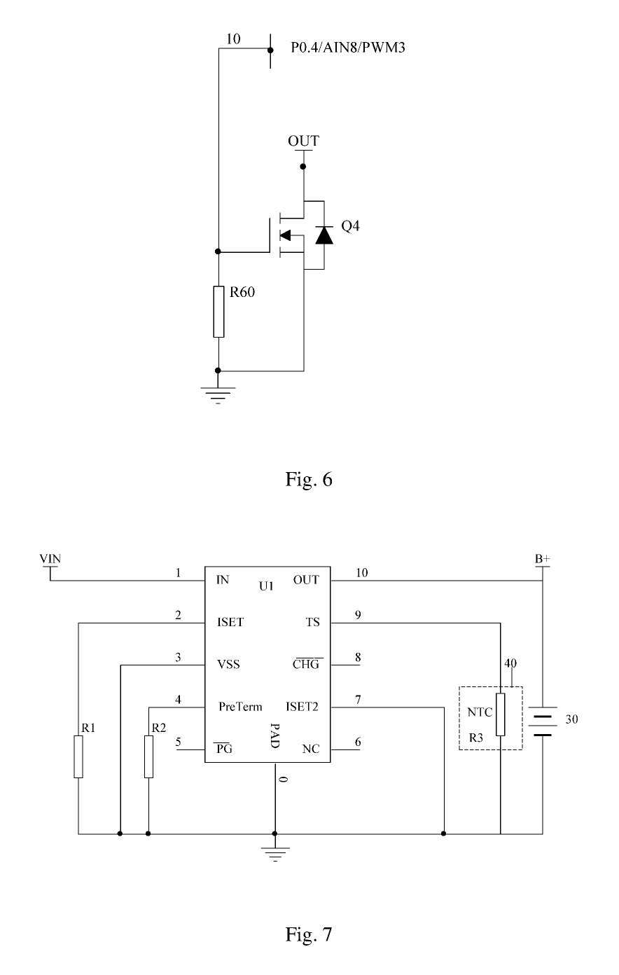

As shown in FIG. 6, the microprocessor module 50 further includes a switch module connected to the microprocessor chip U8, an output end of the switch module is connected to the vaporizer assembly. The vaporizer assembly is connected with the OUT end and the anode B+ of the battery module 30 respectively, as shown in FIG. 6. The grid of the MOSFET Q4 is electrically connected to PWM3 pin of the microprocessor chip U8 and is grounded via a resistor R60, a source of the MOSFET Q4 is grounded, a drain of the MOSFET Q4 is the OUT end of the switch module. OUT1 in FIG. 6 is a test welding spot.

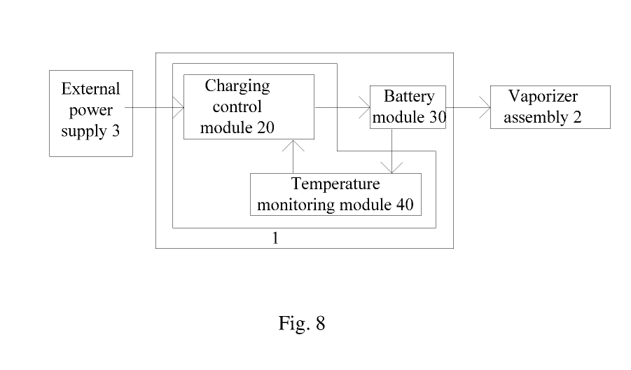

FIG. 7 is an another embodiment of the present application in the FIG. 2; as shown in the circuit schematic view, the circuit configuration in the embodiment is almost same with FIG. 2, furthermore, a pin ISE2 of the chip UI is grounded in this embodiment.

In another aspect, a charging and discharging control method for a battery assembly is provided; and the charging and discharging control method comprises:

a power adapter is electrically connected to an external power supply via a charging port 10;

a temperature monitoring module 40 detects temperature of the battery module 30 in real time;

a charging control module 20 controls charging input of the battery module according to detected temperature of the battery module.

Specifically, in the charging process, the charging control module 20 has a preset temperature threshold range and the temperature monitoring module 40 senses temperature change of the battery module 30; when temperature value of the battery module 30 is in the temperature threshold range, the charging control module 20 charges the battery module according to a set charging input, when the temperature value of the battery module 20 is out of the temperature threshold range, the charging control module 20 reduces the charging input of the battery module 30. Specificly, in the embodiment, the charging control module has multiple preset threshold ranges, such as, if the temperature of the battery module 30 sensed by the NTC thermistor R3 is in the range of 10-45 degree, the battery module is charged at a current set by the second resistor R2; if the temperature is in the range of 45-60 degree, the maximum charging cut-off voltage of the battery module is 4.1 V; if the temperature is in the range of 0-10 degree, the charging current of the battery module is halved; if the temperature is greater than 60 degree or less than 0 degree, the charging is fault, charging circuit of the battery module is cut off.

In the charging and discharging process, the microprocessor module 50 detects voltage of the battery module 30, the microprocessor module 50 sets a reference voltage and compares the voltage of the battery module with the reference voltage, when charging status signal output from the CHG pin of the charging control chip U1 shows the charging process have being finished, if the voltage of the battery module 30 is not match with the charging status signal, the microprocessor module 50 determines temperature of the battery module 30 is abnormal and prompts abnormal temperature status.

Meanwhile, the charging control chip U1 senses environment temperature according to the R3 (NTC), and sends the charging status signal to the microprocessor chip U8 (SN8P2712), U8 receives the charging status signal sent by the U1, and detects voltage of battery, a voltage comparison circuit supply reference voltage, when the voltage is less than a reference voltage and the charging status signal prompts fully charged, the temperature is abnormal, U8 sends an alarm signal and hints user the temperature is abnormal by sound of buzzer U12 or flash of LED, and then the user can take corresponding measures, for example, cuts off the power input of the external power supply, or stops using of electronic cigarette and carry on the corresponding cooling treatment. The measures prevent the user from scalding or prevent the electronic cigarette from overheating explosion.

On the other hand, as shown in FIG. 8, an electronic cigarette is provided, the electronic cigarette comprises an vaporizer assembly 2 used for vaporizing e-liquid and a battery assembly 1 used for supplying power to the vaporizer assembly, the battery assembly comprises a charging port (not shown) for being connected to an external power supply 3, a battery module 30, and a charging control module 20; the battery assembly 30 further comprises a temperature monitoring module 40 used for measuring temperature value of the battery module 30. The invention has arbitrary characteristics and combination of the battery assembly 1 as shown in FIGS. 1-7 and above description, not repeat here.

While the embodiments of the present application are described with reference to the accompanying drawings above, the present application is not limited to the above-mentioned specific implementations. In fact, the above-mentioned specific implementations are intended to be exemplary not to be limiting. In the inspiration of the present application, those ordinary skills in the art can also make many modifications without breaking away from the subject of the present application and the protection scope of the claims. All these modifications belong to the protection of the present application.

1. A battery assembly (1) used for combining with a vaporizer assembly (2) to form an electronic cigarette; the battery assembly (1) comprising a charging port (10), a battery module (30), and a charging control module (20); wherein the battery assembly further comprises a temperature monitoring module (40) used for measuring temperature value of the battery module (30),
the charging control module (20) is electrically connected to the charging port (10), the battery module (30) and the temperature monitoring module (40) respectively; and
the charging control module (20) is used for charging the battery module (30) via an external power supply in the form of DC power via the charging port (10), as well as controlling charging input of the battery module (30) in accordance with the temperature value of the battery module (30) measured by the temperature monitoring module (40).

2. The battery assembly according to claim 1, wherein the charging control module (20) includes a charging control chip (U1), an output end of the charging control chip (U1) is electrically connected to a anode of the battery module (30); a TS pin of the charging control chip (U1) is electrically connected to the temperature monitoring module (40) and is further connected to a cathode of the battery module (30) via the temperature monitoring module (40).

3. The battery assembly according to claim 2, wherein the charging control chip (U1) has a preset temperature threshold, output voltage of the charging control chip (U1) is controlled in according with a comparing result between the temperature threshold and the temperature value obtained from the temperature monitoring module (40) via the TS pin of the charging control chip (U1).

4. The battery assembly according to claim 2, wherein the temperature monitoring module includes a first resistor and a second resistor, a ISET pin of the charging control chip (U1) is grounded via the first resistor, and a PRE-TERM pin of the charging control chip (U1) is grounded via the second resistor.

5. The battery assembly according to claim 2, wherein the temperature monitoring module (40) is a NTC thermistor, the NTC thermistor detects temperature of the battery module (30) by clinging the battery module (30).

6. The battery assembly according to claim 2, wherein type of charging control chip (U1) is BQ24090.

7. The battery assembly according to claim 1, wherein the battery assembly further includes a microprocessor module (50), the microprocessor module (50) separately connects to the battery module (30) and the charging control module (20),the microprocessor module (50) detects voltage of the battery module (30) and determines whether temperature of the battery module (30) is abnormal and hints the abnormal temperature status in accordance with charging status signal of the battery module received from the charging control module (20).

8. The battery assembly according to claim 7, wherein the microprocessor module (50) includes a microprocessor chip (U8), a voltage comparison module and a prompt module separately connecting to the microprocessor chip (U8), a XIN pin of the microprocessor chip is electrically connected to a CHG pin of the charging control chip (U1), a reset pin of the microprocessor chip is electrically connected to an input end of DC (VIN).

9. The battery assembly according to claim 8, wherein the input end of DC (VIN) is grounded via a first divider resistor and a second divider resistor in series, the reset pin of is electrically connected to connection end of the first divider resistor and the second divider resistor.

10. The battery assembly according to claim 8, wherein the voltage comparison module includes a third resistor, a fourth resistor, a fifth resistor, a first capacitance and a three terminal voltage regulator (U10), therein,
an end of the third resistor is electrically connected to the anode of the battery module (30), the other end of the third resistor is electrically connected to AIN3 pin of the microprocessor chip;
an end of the fourth resistor is electrically connected to the AIN3 pin, the other end of the fourth resistor is electrically connected to first end of the first capacitance and AIN2 pin of the microprocessor chip;
an end of the fifth resistor is electrically connected to the anode of the battery module (30), the other end of the fifth resistor is electrically connected to second end of the first capacitance and a cathode of the three terminal voltage regulator;
an anode of the three terminal voltage regulator (U10) is electrically connected to the AIN2 pin, a gate of the three terminal voltage regulator is electrically connected to second end of the first capacitance, the cathode of the three terminal voltage regulator (U10) is electrically connected to one end of the fifth resistor and AVREFG pin of microprocessor chip (U8).

11. The battery assembly according to claim 10, wherein the microprocessor module (50) includes a switch module connected to the microprocessor chip (U8), output end of the switch module is connected to the vaporizer assembly.

12. The battery assembly according to claim 11, wherein the switch module includes a field effect transistor (Q4) and a sixth resistor, a grid of the FET (Q4) is electrically connected to PWM3 pin of microprocessor chip (U8), a source of the FET (Q4) is grounded, a drain of the FET (Q4) is the output end of the switch module, an end of the sixth resistor is electrically connected to the grid of the FET (Q4), the other end of the sixth resistor is grounded.

13. The battery assembly according to claim 10, wherein the prompt module includes a sound device and/or a LED light.

14. The battery assembly according to claim 8, wherein a Xout pin of the microprocessor chip (U8) is connected to an airflow sensor, the anode of battery module (30) is electrical connected to the airflow sensor and supplies power to the airflow sensor.

15. A charging and discharging control method for a battery assembly (30), wherein the charging and discharging control method comprises:
a power adapter is electrically connected to an external power supply via a charging port (10);
a temperature monitoring module (40) detects temperature of the battery module (30) in real time;
a charging control module (20) controls charging input of the battery module (30) according to detected temperature of the battery module.

16. The charging and discharging control method for the battery assembly according to claim 15, wherein in the charging process, the charging control module (20) has a preset temperature threshold range and the temperature monitoring module (40) senses temperature change of the battery module (30); when a temperature value of the battery module (30) is in the threshold range, the charging control module (20) charges the battery module (30) in accordance with a set charging input, when the temperature value of the battery module (30) is out the threshold, the charging control module (20) reduces the charging input of the battery module (30).

17. The charging and discharging control method of the battery assembly according to claim 15, wherein the battery assembly also includes a microprocessor module (50) connected to the charging control module (20), in the charging and discharging process, the microprocessor module (50) detects voltage of the battery module (30) and receives charging status signal from the charging control module (20), the microprocessor module (50) has a preset reference voltage and compares the detected voltage of the battery module (30) with the reference voltage, when the voltage of the battery module (30) is different from the reference voltage, the microprocessor module (50) determines temperature of the battery module (30) being abnormal and prompts abnormal information.

18. The charging and discharging control method of the battery assembly according to claim 15, wherein the charging control module (20) has multiple threshold ranges,
if temperature of the battery module (30) sensed by the temperature monitoring module (40) is in the range of 10 degree to 45 degree, the battery module (30) is charged at a setting current;
if temperature of the battery module (30) sensed by the temperature monitoring module (40) is in the range of 45 degree to 60 degree, the maximum charging cut-off voltage of the battery module (30) is 4.1 V;
if temperature sensed by the temperature monitoring module (40) is in the range of 0 degree to 10 degree, the charging current of the battery module (30) is halved;
if temperature sensed by the temperature monitoring module is greater than 60 degree and less than 0 degree, the charging is fault, charging circuit of the battery module is cut off.

19. An electronic cigarette, the electronic cigarette comprises the vaporizer assembly (2) used for vaporizing e-liquid and the battery assembly (1) used for supplying power to the vaporizer assembly, wherein the battery assembly (1) comprises a charging port (10), a battery module (30), and a charging control module (20); the battery assembly further comprises a temperature monitoring module (40) used for measuring temperature value of the battery module (30),
the charging control module (20) is electrically connected to the charging port (10), the battery module (30) and the temperature monitoring module (40) respectively;
the charging control module (20) is used for receiving DC power via the charging port (10) to charge the battery module (30) via an external power supply, and controlling charging input of the battery module (30) in accordance with temperature value of the battery module (30) measured by the temperature monitoring module (40).

20. The electronic cigarette according to claim 19, wherein the battery assembly further includes a microprocessor module (50), the microprocessor module (50) separately connects to the battery module (30) and the charging control module (20), the microprocessor module (50) detects discharge voltage of the battery module (30) and determines whether temperature of the battery module (30) is abnormal and hints abnormal temperature status in accordance with charging status signal of the battery module (30) received from the charging control module (20).
